(19) United States
(12) Patent Application Publication
(10) Pub. No.: US 2003/0175455 A1
(43) Pub. Date: Sep. 18, 2003

(54) Structural element made from fibre-reinforced plastic

(76) Inventors: Thiemo Erb, Stuttgart (DE); Patrick Kim, Stuttgart (DE); Martin Koschmieder, Stuttgart (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/366,707

(22) Filed: Feb. 14, 2003

(30) Foreign Application Priority Data
Feb. 14, 2002 (DE) 102 05 965.9-16

(51) Int. Cl. B32B 1/08

(52) U.S. Cl. 428/36.1

(57) ABSTRACT

A structural element made from fibre-reinforced plastic which has a multilayer structure comprising different types of fibre and different fibre orientations. The structural element includes at least one inner layer, which surrounds a substantially hollow core, an intermediate layer having at least one preferred fibre orientation in the direction of a load axis of the structural element, and an outer layer having electrically insulating fibres.

### BACKGROUND AND SUMMARY OF THE INVENTION

This application claims the priority of German Application No. 102 05 965.9-16, filed Feb. 14, 2002, the disclosure of which is expressly incorporated by reference herein.

The invention relates to a structural element made from fibre-reinforced plastic.

Fibre-reinforced plastics (FRPs), which are known from the aeronautical and aerospace sector, are increasingly being used as structural elements in the automotive industry. FRPs are bring used because of the increased need for a lightweight structure, which in turn justify higher production costs, and, on the other hand, optimizations with regard to the production process for FRP materials, which also make it possible to reduce costs.

There are various ways of building up structural elements from FRP; what is known as the sandwich method is in particularly widespread use. In this method, a hollow profiled section made from FRP is provided with a core or built up around a core. This core preferably consists of foams or natural materials, such as balsa wood. The core materials make a significant contribution to the rigidity of the component.

Drawbacks of the core materials include the additional costs and unsuitability of these materials for the process used for the production of vehicle bodyshells. To coat the metallic elements of the bodyshell, the latter is subjected to liquid cathode dip painting (CDP) at approx. 190 [symbol] C. FRP components which include foams or wood as a core are relatively unsuitable for this process. Foams tend to foam further at these temperatures, while wood sucks up the solution to saturation point. Moreover, high-strength carbon fibre components also lead to contact corrosion with the surrounding metal components of the bodyshell structure.

Therefore, the object of the invention is to provide a structural element made from FRP material which has a high damage tolerance and a high rigidity and is suitable for cathode dip painting. Furthermore, the structural element must not cause any contact corrosion with the surrounding bodyshell.

The structural element according to the invention has a multilayer structure including different types of fibre and fibre orientations. These include an inner layer, an intermediate layer and an outer layer. The inner layer surrounds a substantially hollow core. The intermediate layer contributes in particular to the strength of the structural element. For this purpose, the fibres are oriented in the preferred force direction, in which the load is applied to the structural element. The outer layer is used to form the final contour of the structural element, and is also designed with electrically insulating fibres, with the result that contact corrosion with the adjoining metallic structural elements of the bodyshell is avoided.

The inventive structure makes it possible to dispense with a core material while nevertheless ensuring the same strength and damage tolerance as with comparable sandwich structures. Moreover, the structural element is suitable for the CDP process.

The inner layer is expediently formed by one or more braided tubes. A plurality of braided tubes next to one another result in a honeycomb cross section in the structural element. The honeycombs may be configured in any desired form (polygonal or round) and are delimited by webs. The webs result from contact surfaces between the braided tubes and make a contribution to the strength of the structural element. The number of the braided tubes or of the resulting honeycomb cells is preferably between 2 and 6, particularly preferably between 3 and 5.

If the longitudinal axis of the structural element is along the direction having a high level of force introduced (load axis), it is expedient that the braided tube of the inner layer has a fibre content along the load axis. The fibres of the braided tube are generally arranged at a 60 [symbol] angle with respect to one another and run at a 30 [symbol] angle with respect to the longitudinal axis.

The fibres of the inner layer are preferably glass fibres. These are inexpensive and have a high elongation, which has beneficial effects on the damage tolerance.

In contrast, the intermediate layer is preferably formed by carbon fibres or aramid fibres which have a significantly higher strength than the glass fibres of the inner layer. However, the carbon fibres are more brittle than the glass fibres.

The fibre orientation of the intermediate layer has a preferred orientation along the maximum action of force of the structural element. It is particularly preferable for the fibre orientation to be arranged unidirectionally along a longitudinal axis of the structural element.

The outer layer is, in turn, like the inner layer, expediently formed by a braided tube. This braided tube surrounds the inner layers and prevents delamination.

The fibres of the outer layer, like the fibres of the inner layer, are preferably formed by glass fibres. This provides a cost-effective structual element with increased damage tolerance. A further important point is that glass fibres are electrically insulating and, particularly if the intermediate layer is composed of carbon fibres, the glass fibres of the outer layer prevent direct contact between the carbon fibres and adjoining metal elements.

The structural element according to the invention is preferably attached to a bodyshell by means of at least one attachment element, which is, in turn, preferably metallic.

The attachment element may be integrated in the layers of the structural element, for example may be laminated between the layers (if no contact corrosion occurs as a result) or may be adhesively bonded to the structural element.

Other objects, advantages and novel features of the present invention will become apparent from the following detailed description of the invention when considered in conjunction with the accompanying drawings.

### BRIEF DESCRIPTION OF THE DRAWINGS

Preferred embodiments of the structural element according to the invention are explained in more detail with reference to the following figures, in which:

FIG. 1 shows a curved structural element made from FRP material,

FIG. 2 shows an illustration of the layers of the structural element from FIG. 1,

FIG. 3 diagrammatically depicts the integration of a structural element in a vehicle bodyshell, and

FIG. 4 shows a three-dimensional illustration of the attachment of a structural element to a vehicle bodyshell.

### DETAILED DESCRIPTION OF THE PREFERRED EMBODIMENTS

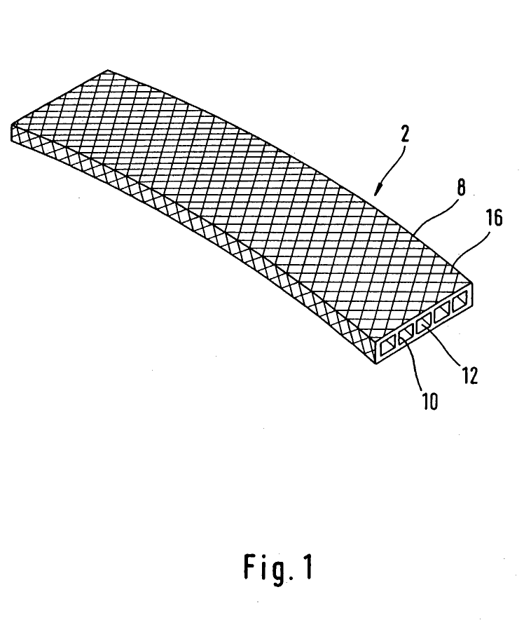

FIG. 1 shows a structural element which is used as a roof crossmember of a vehicle bodyshell. The structural element has a curvature in the longitudinal direction. In a core of the structural element there are cavities 12, which are configured in the form of passages. The cavities 12 are separated from one another by webs 10.

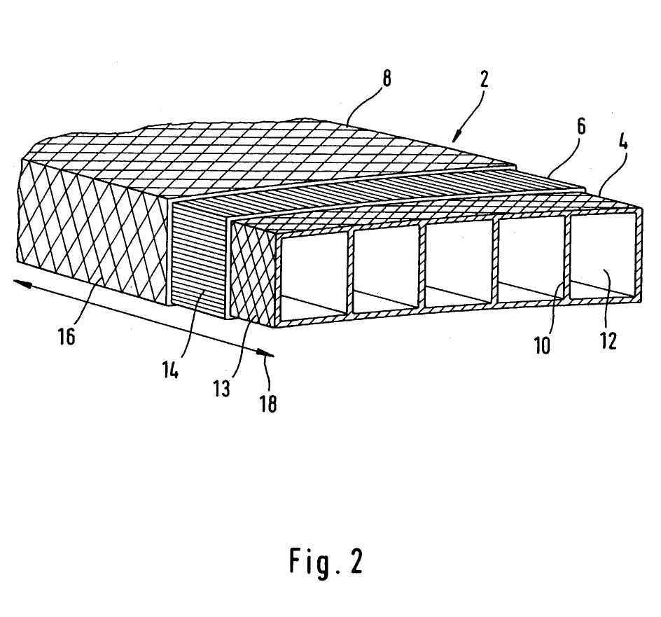

The structure of element 2 is shown in FIG. 2. The three layers of the structural element in accordance with the invention are illustrated set back from one another in FIG. 2, so that the essential layers can be seen. These are the inner layer 4, the intermediate layer 6 and the outer layer 8.

An advantageous way of producing the structural element according to the invention is explained below:

In FIG. 2, the inner layer 4 comprises five braided tubes which are arranged next to one another. For this purpose, the braided tubes are drawn onto plastic film tubes using a process which is known per se, and a plurality of covered plastic film tubes next to one another are surrounded by the intermediate layer 6, and this structure, in turn, is covered by a larger braided tube, which forms the outer layer 8. This assembly is introduced into a moulding tool, the plastic film tubes in the core are inflated, so that the mould is filled. The free spaces between the fibres are filled under pressure with resin. The resin is cured and the plastic film tubes are removed. The cavities 12 in the core remain in place. The braided tubes of the inner layer 4, which have been adhesively bonded to one another by the resin, form the webs 10.

The resin, which forms a matrix of the FRP, is preferably a high-temperature phenolic resin with a softening point Tg of approx. 190 [symbol] C. The braided tubes of the inner layer have a cross-braid, which may include an additional fibre fraction in the direction of the component longitudinal axis 18. The fibres 13 of the inner layer consist of glass fibres.

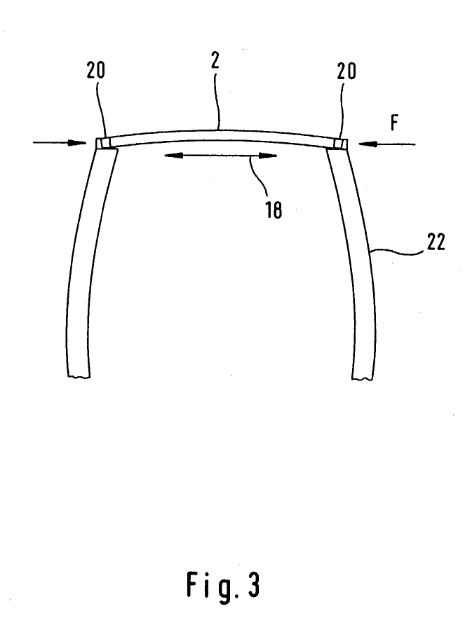

The intermediate layer 6, which consists of carbon fibres 14, has been laminated onto the inner layer 4. The carbon fibres 14 are oriented along the longitudinal axis 18. This corresponds to the main force direction which acts on the structural element under load (cf. FIG. 3). The carbon fibres 14 have a sufficient strength for this load situation.

To avoid a sudden (catastrophic) brittle fracture, the outer layer 8 once again consists predominantly of glass fibres 16. Although the glass fibres 16 of the outer layer and the glass fibres 13 of the inner layer 4 do not have the same strength as the carbon fibres 14, they are distinguished by a high elongation. Moreover, the fibres 16 of the outer layer 8 are once again formed as a braided tube, thus preventing delamination of the individual layers, which are held bundled together by the outer layer 8.

The combination of particularly strong and particularly elastic fibres and the arrangement of the high-strength fibres along the main force direction leads to the desired properties of the structural element 2, making it possible to dispense with a core material. The honeycomb structure which is formed by the webs 10 and the passages 12 also contributes to improving the strength. The glass fibres 16 of the outer layer 8 have a further advantageous effect, since they keep the electrically conductive carbon fibres 14 in the intermediate layer 6 away from the metallic components and thereby prevent contact corrosion.

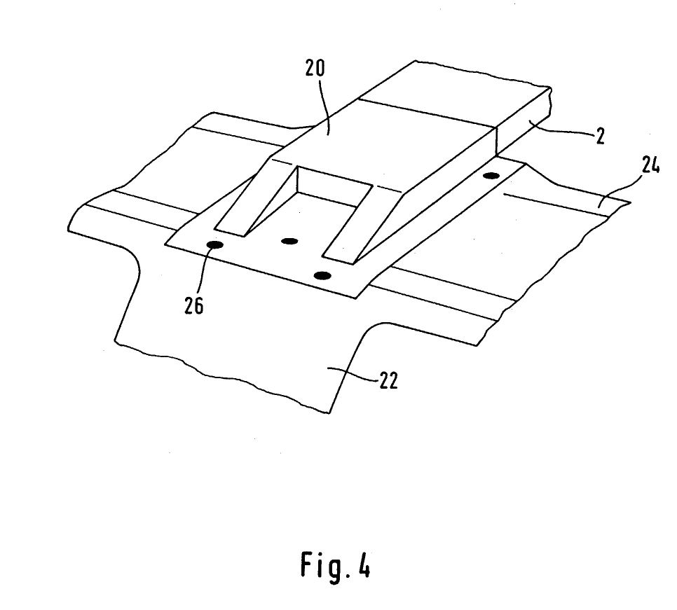

FIG. 3 diagrammatically depicts the installation of the structural element 2 according to the invention (as a roof crossmember 2) as shown in FIGS. 1 and 2. The roof crossmember 2 connects a left-hand side of the vehicle and a right-hand side of the vehicle at the level of the B pillars 22 and in the event of a side impact (indicated by the force lines F) prevents the B pillars 22 from bending inwards. The roof crossmember 2 has been welded to the B pillars 22 by attachment elements 20. The attachment elements 22 have in turn been fitted and adhesively bonded onto the roof crossmember 2, so that they are joined to the latter in a positively locking manner and by material-to-material bonding and are able to transmit the force F to the roof crossmember 2. In accordance with these statements, FIG. 4 shows a three-dimensional illustration of an attachment element 20 which has been welded to the roof pillar 24 at the level of the B pillar 22 by means of spot welds 26.

In principle, the structural element according to the invention can be fitted to all parts of a vehicle bodyshell or chassis. The structural element may also be of flat design, for example, in the form of a partition. The fibres of the intermediate layer are then oriented along the main force directions which occur.

The choice of fibres described—glass fibres for inner and outer layers, carbon fibres for intermediate layer—is an expedient selection which has proven suitable in practice. It offers a good compromise between costs, mass, strength and elongation for the structural element described. If the weighting of these criteria changes to match the demands in other components, other fibre combinations may also be expedient. For example, if the demands on the strength are lower, it is also possible for the intermediate layer to consist of glass fibres. This measure reduces the costs of the component. If the demands are higher, for example, as a result of a plurality of load directions, it may be expedient to introduce additional layers. This can be effected, for example, by means of a second intermediate layer with fibres in a different preferred orientation. Furthermore, the fabrics of the individual layer may be formed from mixed fibres, for example from aramid and polyethylene fibres.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A multilayer fiber-reinforced plastic structural element comprising: at least one inner layer, which surrounds a substantially hollow core, at least one intermediate layer having at least one preferred fibre orientation in a direction of a load axis of the structural element, and an outer layer including electrically insulating fibres.

2. The structural element according to claim 1, wherein the inner layer comprises at least one braided tube.

3. The structural element according to claim 1, wherein the inner layer comprises a plurality of braided tubes, which form webs in the cross section of the structural element.

4. The structural element according to claim 1, wherein the plurality of braided tubes of the inner layer have fibres along a longitudinal axis.

5. The structural element according to claim 1, wherein the inner layer comprises glass fibres.

6. The structural element according to claim 1, wherein the intermediate layer comprises carbon or aramid fibres.

7. The structural element according to claim 6, wherein the fibres of the intermediate layer are arranged unidirectionally along the longitudinal axis.

8. The structural element according to claim 1, wherein the outer layer comprises a braided tube.

9. The structural element according to claim 1, wherein the outer layer comprises glass fibres.

10. The structural element according to claim 1, further including at least one attachment element for attaching it to a bodyshell.

11. The structural element according to claim 10, wherein the attachment element is one of integrated in the layers of the structural element and adhesively bonded to the structural element.
